(19) United States
(12) Patent Application Publication
(10) Pub. No.: US 2016/0189320 A1
(43) Pub. Date: Jun. 30, 2016

(54) SYSTEM AND METHOD FOR REAL ESTATE BUSINESS MANAGEMENT

(71) Applicant: Anothony ODDO, Ozark, MO (US)

(72) Inventor: Anothony ODDO, Ozark, MO (US)

(21) Appl. No.: 14/832,977

(22) Filed: Aug. 21, 2015

Related U.S. Application Data
(60) Provisional application No. 62/040,749, filed on Aug. 22, 2014.

(51) Int. Cl. G06Q 50/16; G06Q 50/20; G06Q 30/06; G06Q 30/02

(52) U.S. Cl. CPC G06Q 50/16; G06Q 30/0255; G06Q 50/2057; G06Q 30/0627

(57) ABSTRACT

Methods for managing real estate using a computer-implemented real estate management program and selectively presenting real estate properties in a web browser using a computer-implemented system. The methods provide automatic servicing of buyers based on buyer viewing history and web browser usage as well as providing metric based coaching for agents that takes into consideration sales activities.

### RELATED APPLICATIONS

This application claims priority to U.S. Provisional Application No. 62/040,749 filed Aug. 22, 2014. The entire contents of the above application are hereby incorporated by reference as though fully set forth herein.

### FIELD

The present invention relates to computerized methods and systems for the real estate business. More particularly, the present invention relates to computerized methods and systems for tracking real estate views online by buyers as well as leads and appointments by buyers and sellers. The methods and systems are implemented in computer hardware and software.

### BACKGROUND

Real estate listings are presently handled by a Multiple Listing Service (MLS) Regional information system. This MLS system is designed for the use of buyers, sellers and agents who currently retrieve real estate information from this system to service their customers. The MLS system is a Multiple Listing Database that includes residential, multifamily, commercial, and land real estate listings for the purpose of buying, selling or leasing those properties through a central database.

Even though buyers are increasingly dependent on the Internet to locate and purchase property, a system is not available capable of automatic servicing buyers based on buyer viewing history and/or buyer software choices or web browser usage. The present invention provides systems and methods directed towards database use by buyers, sellers and agents. Additionally, a system is not available capable of metric based coaching for agents that takes into consideration sales activities. The present invention provides systems and methods directed toward metric based coaching of agents.

There is also a need to display more relevant real estate property information to the buyer based upon generalizations about the user's income surrounding their choice of operating systems and web browsers. The present invention provides a tailored presentation of real estate properties based upon these generalizations.

### BRIEF SUMMARY OF THE INVENTION

It is the object of the present invention to address several challenges in previous attempts to improve lead generation and sales of MLS listed properties. In one embodiment of the invention, a method for managing real estate using a computer-implemented real estate management program is disclosed, the method comprising (1) generating a user login to allow user to view real estate properties; (2) generating a user profile stored in a database containing at least the user's phone number and email address; (3) correlating user views of real estate properties with the user profile in the database; (4) tracking the number of correlated views by the same user; and (5) accessing the profile stored in the database to generate a notification to the user based upon the correlated views when the correlated views reach a predetermined number of instances for at least one real estate property.

In another embodiment of the present invention, a method for managing real estate using a computer-implemented real estate management program is disclosed, the method comprising (1) generating a user login associated with a user profile stored in a database; (2) tracking the user's number of leads, number of appointments set and number of closed sales of real estate properties; (3) associating the user's number of leads, number of appointments set and number of closed sales of real estate properties with the user profile in the database; (4) generating at least one training module; (5) accessing the database to view a user profile with respect to the number of leads, number of appointments set and number of closed sales within a predetermined time frame; and (6) determining a ratio between user's number of leads and number of appointments set and comparing to a predetermined ratio value wherein if the ratio of user's number of leads to number of appointments set is higher than the predetermined ratio, the user is prompted to complete the at least one training module.

The method further comprises determining a ratio between user's number of appointments and number of closed sales and comparing to a predetermined ratio value wherein if the ratio of user's number of appointments to number of closed sales is higher than the predetermined ratio, the user is prompted to complete the at least one training module. The method further comprises accessing the database to view a user's total amount of sales within a predetermined time frame and determining an amount of sales wherein if the user's total amount of sales within the predetermined time frame is below a predetermined value, the user is prompted to complete the at least one training module.

In a third embodiment of the present invention, a method for selectively presenting real estate properties in a web browser using a computer-implemented system is disclosed, the method comprising (1) selecting a location of real estate properties; (2) determining the web browser used to select location; (3) calculating the average price of real estate properties in a predetermined area around the selected location; (3) correlating a price range around the calculated average price of real estate properties to the web browser; and (4) displaying real estate properties within the price range.

### BRIEF DESCRIPTION OF THE DRAWINGS

FIG. 1 is a flow chart showing how buyers use the system of the present invention.

FIG. 2 is a flow chart showing how agents use the system of the present invention.

FIG. 3 is a software screenshot showing buyer user login creation.

FIG. 4 is a software screenshot showing a lead profile.

FIG. 5 is a software screenshot showing a sample property display.

FIG. 6 is a software screenshot showing monitoring of the number of property views.

FIG. 7 is a software screenshot showing the blast and behavior email set up.

FIG. 8 is a software screenshot showing analytics of the present invention.

FIG. 9 is a software screenshot showing analytics of the present invention.

FIG. 10 is a software screenshot showing analytics of the present invention.

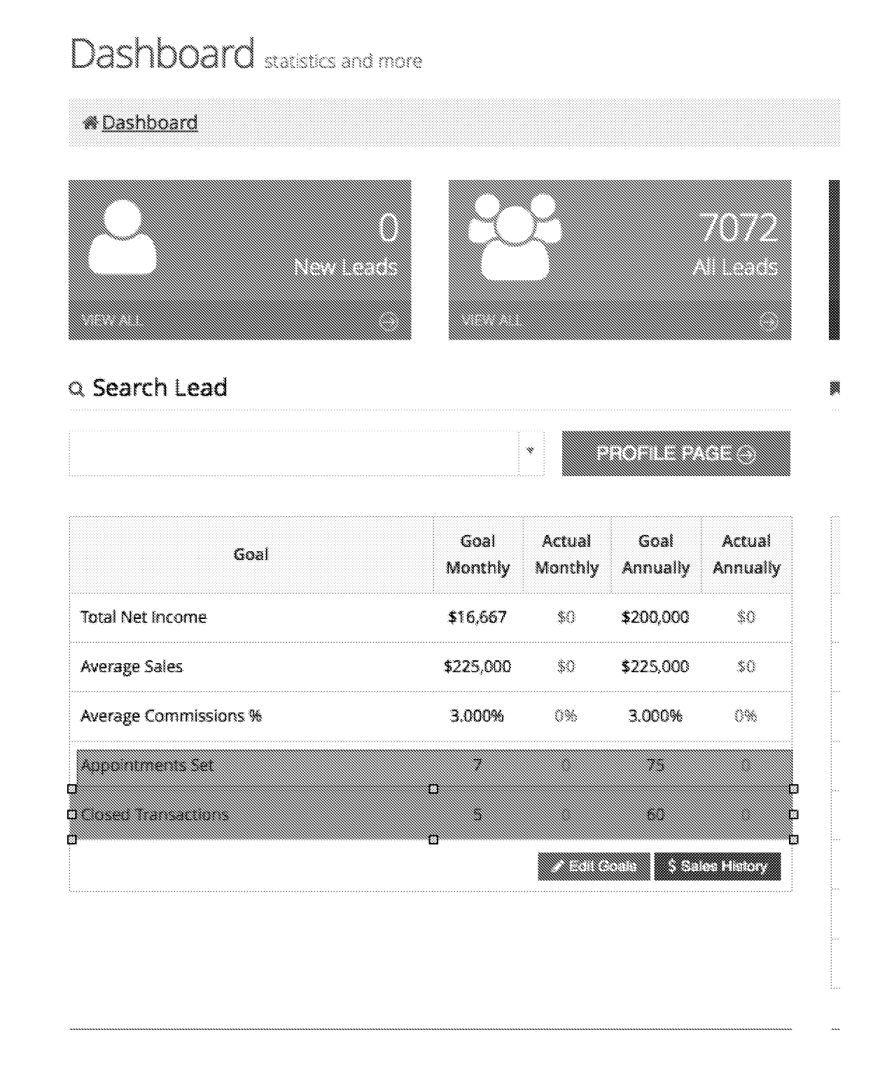

### DETAILED DESCRIPTION

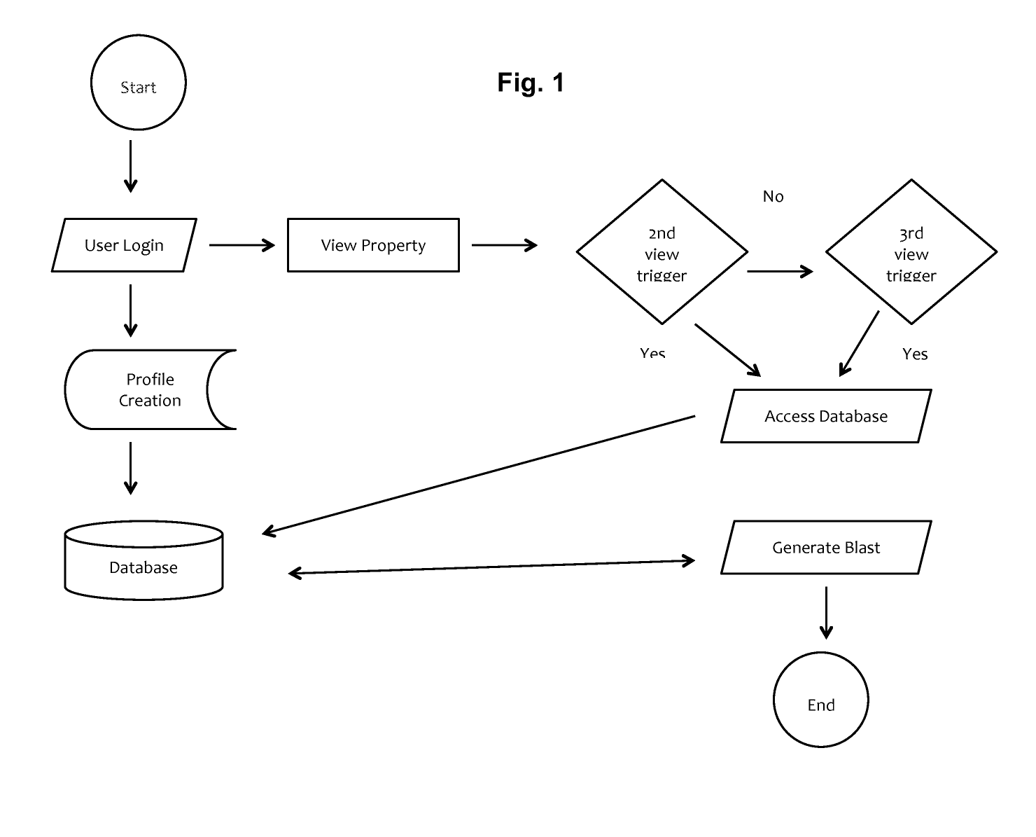

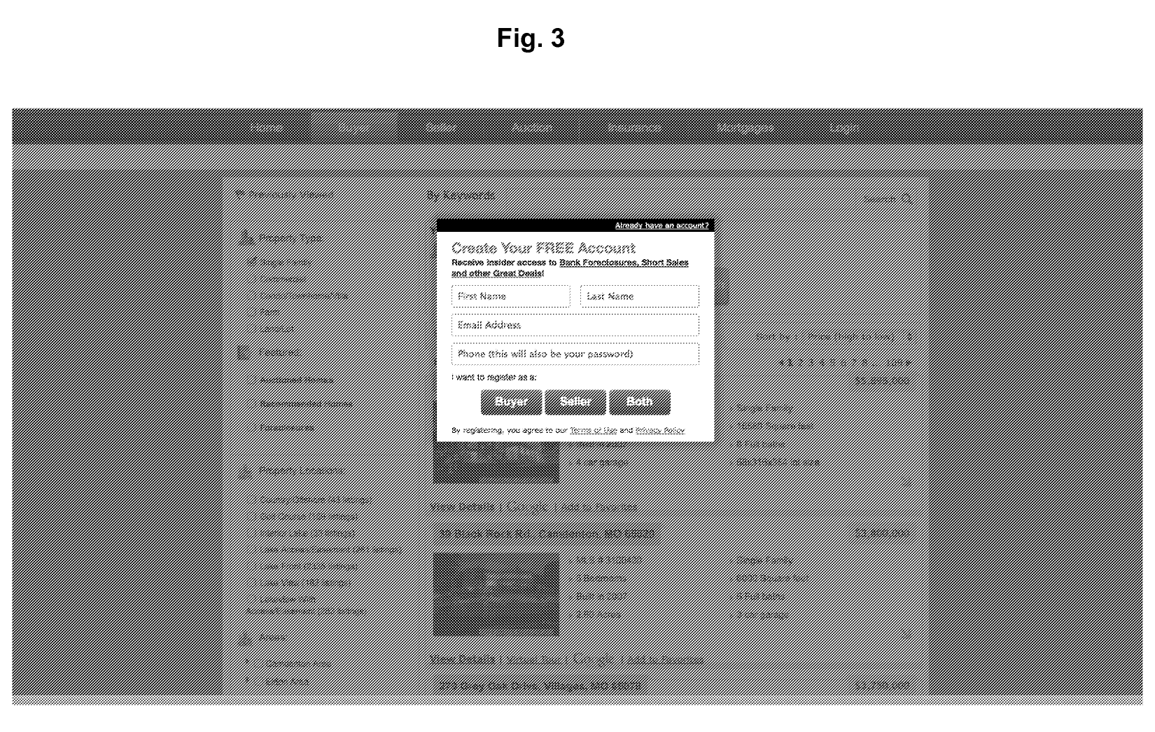

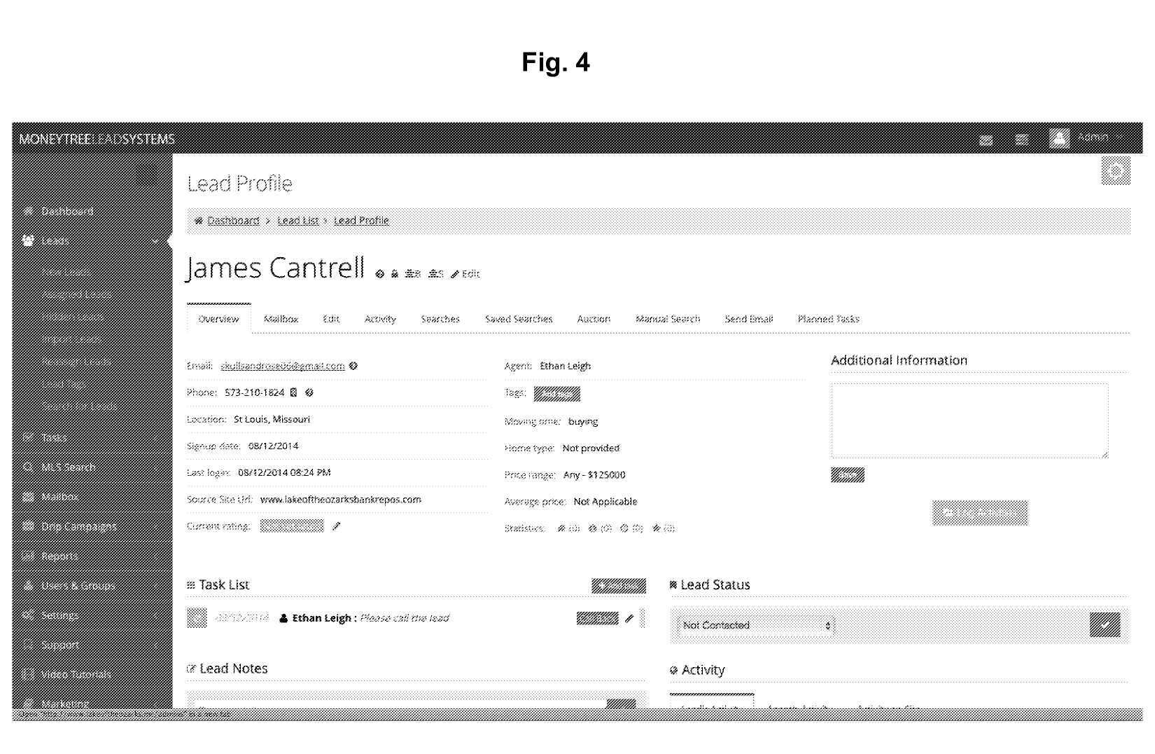

One embodiment of the present invention is a system and method for buyers to view and automatically get information from agents about properties that they have indicated interest by viewing multiple times. Turning to FIG. 1, a user creates a login as shown in FIG. 3, wherein the user may register as a buyer, seller or both. In order to register, the user must enter their phone number, which is integral to the function of the “voice blast” discussed below. As show in FIG. 1, after login creation, the user creates a profile of information that creates a lead profile that is stored in a database. The lead profile is shown in further detail in FIG. 4.

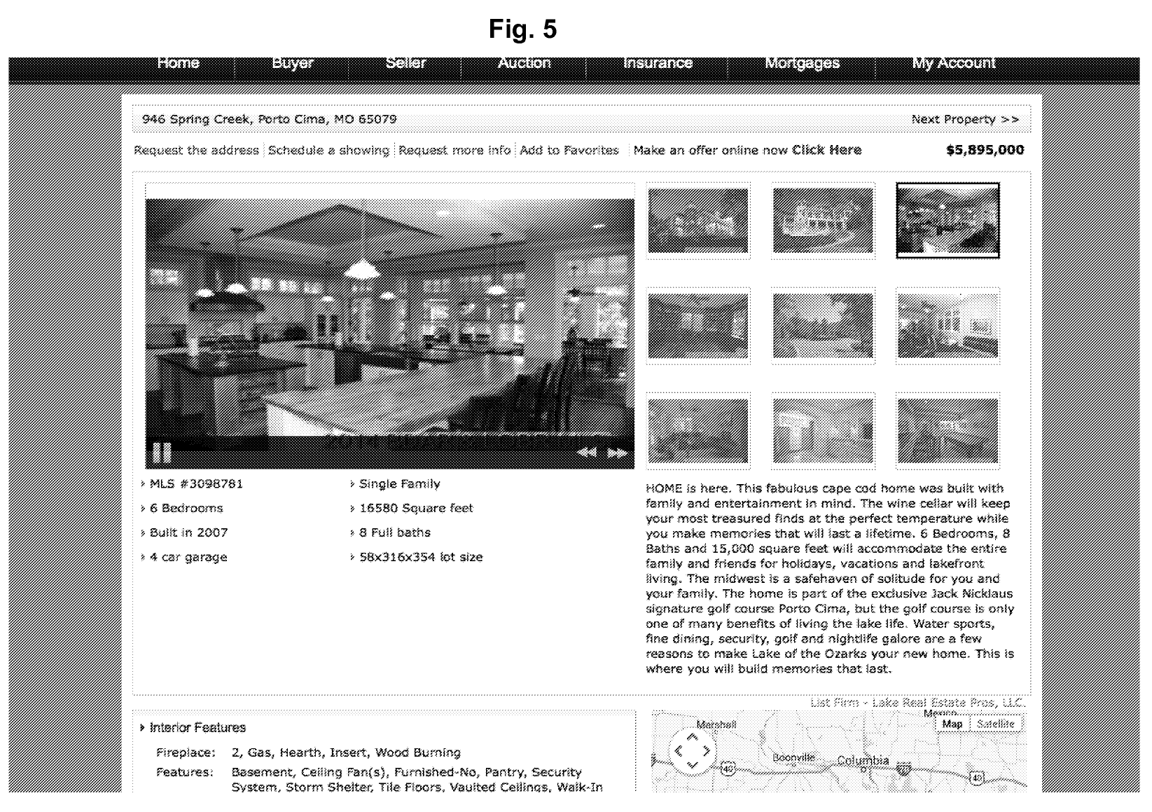

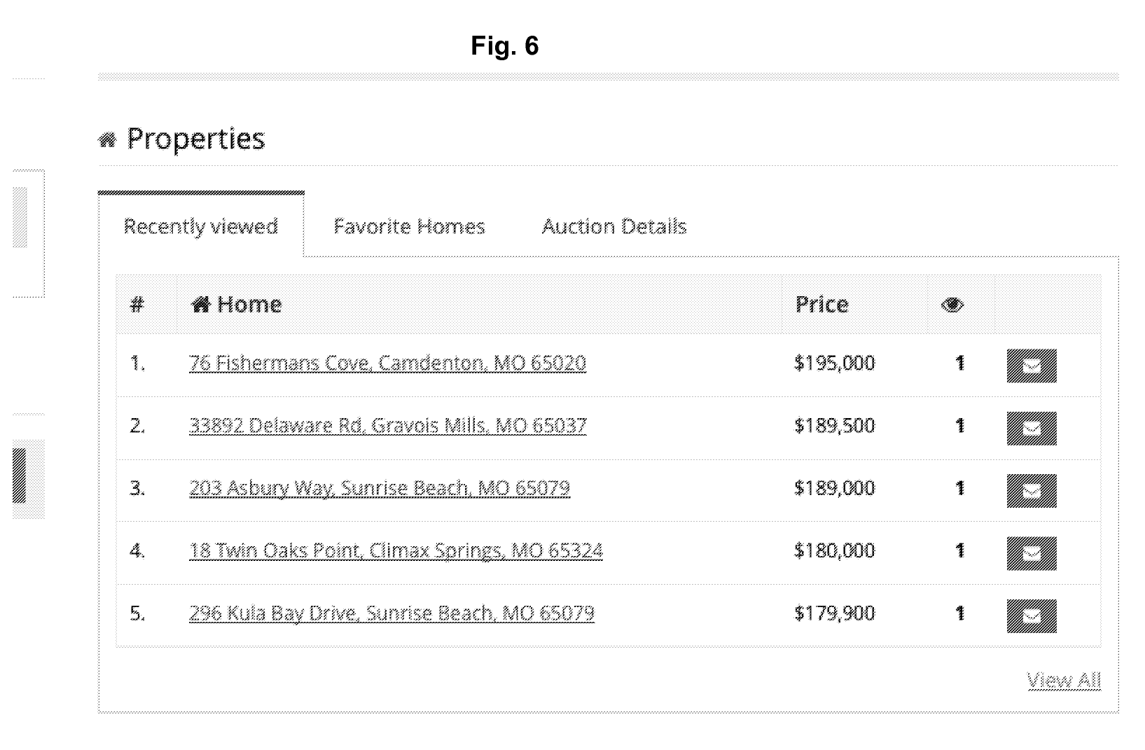

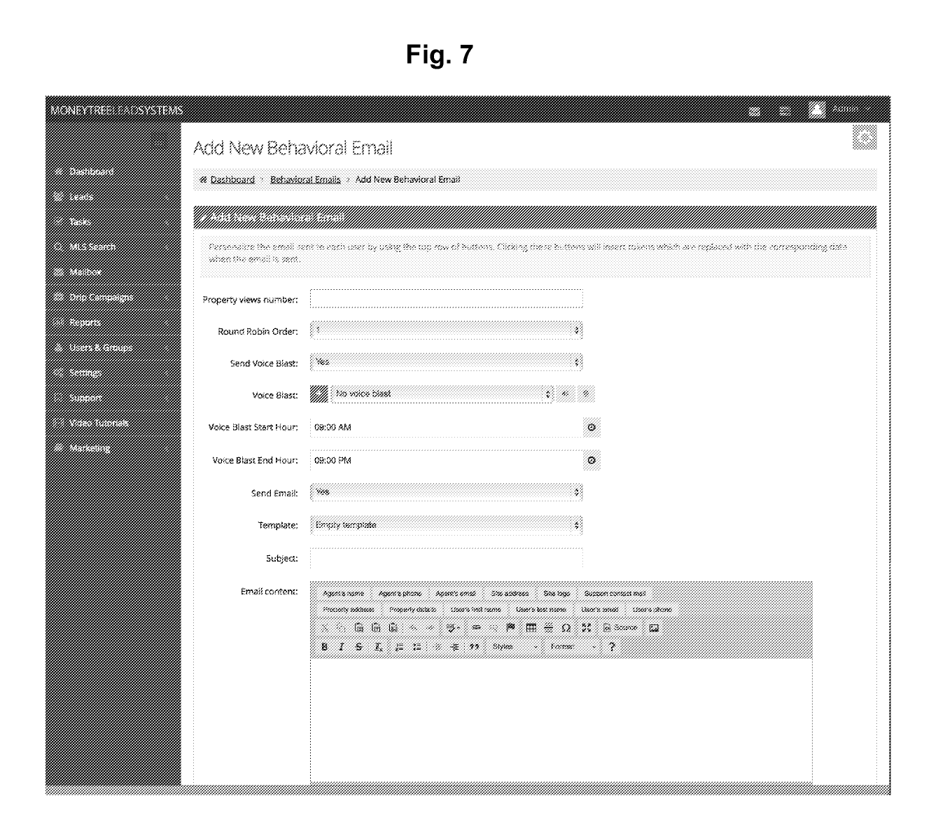

After the user login, profile creation and database storage of the lead profile, a user may view a property as shown in FIG. 5. That property is logged under the user profile as viewed and the number of times the property is viewed is tracked, as shown in FIG. 6. Turning back to FIG. 1, when the user views a property for a number of predetermined times, such as second or third viewing, the profile information from the database is accessed and a voice blast is generated as the user is identified by their unique user ID created by the email address and password entered. The voice blast contains pre-recorded information about the property and is sent directly to the user's phone as a voice or text message. As shown in FIG. 7, the blast parameters and a notification email may be set up under “behavioral emails” wherein the number of property views are set, the voice blast options are entered such that the blast is only sent during certain hours, and a personalized email may be sent from the agent to the user regarding the property to the user's email address.

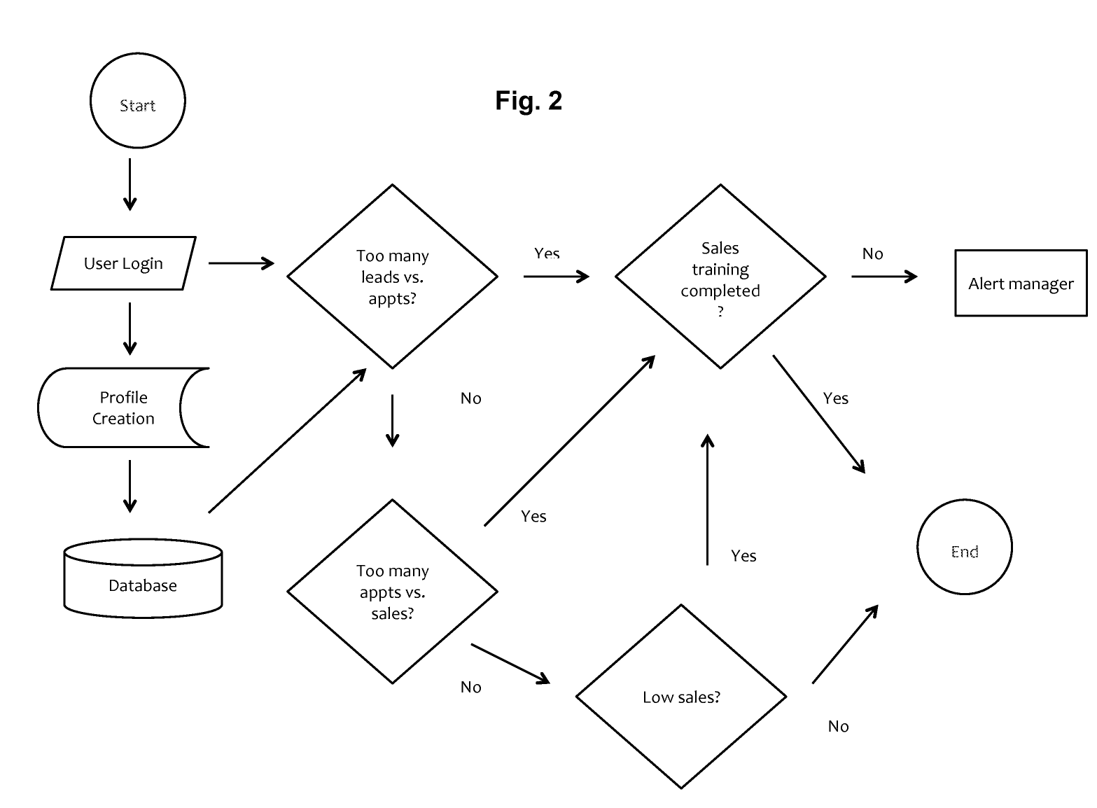

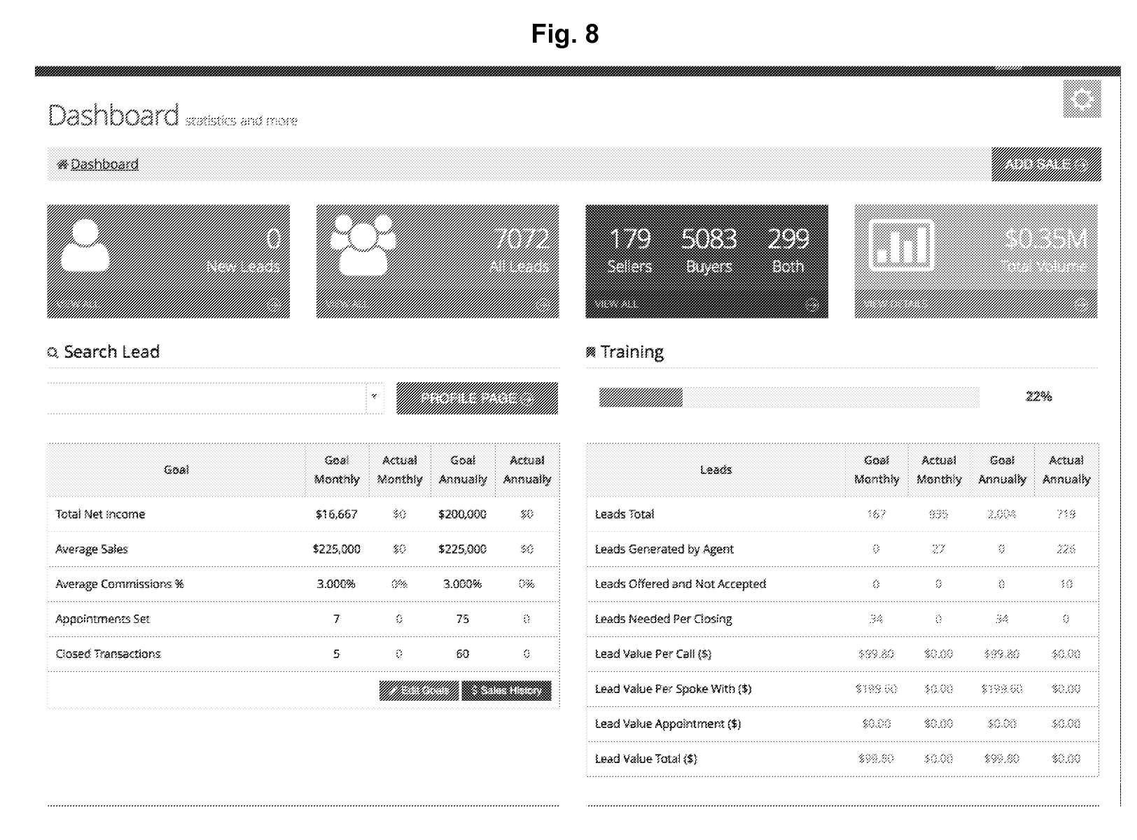

In a second embodiment of the present invention, a viewer analytics coaching based system to increase success with leads is disclosed. Turning to FIG. 2, an agent creates a user login and a profile that is stored in a database along with all their appointments, leads and sales. For example, as shown in FIG. 8, an agent's details are tracked, including but not limited to: total net income, average sales, appointments set, closed transactions, total leads, leads generated by agent, leads offered and not accepted, leads needed per closing, lead value per call (voice blast), lead value per user spoken with money amount, lead value appointments money amount, lead value total money amount and percentage of training completed.

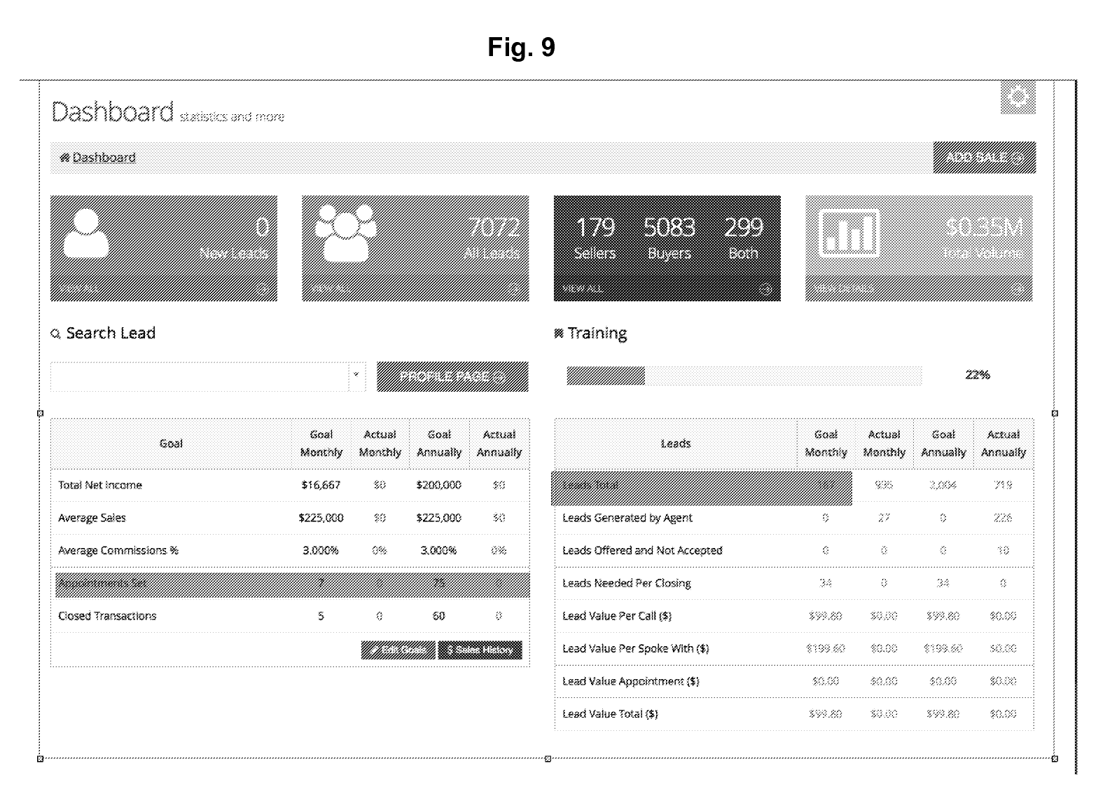

Using the detailed analytics of the system, if a buyer or seller agent has too many leads and not enough appointments, as shown in FIG. 9 wherein the agent has 719 annual leads but 0 appointment set, the system triggers a training module request to the agent. The system tracks whether or not the suggested training was completed. This allows a business to monitor the performance of their agents. Additionally, using the detailed analytics of the system, if a buyer or seller agent has too many appointments and not enough sales, the system triggers a training module request to the agent. Finally, using the detailed analytics of the system, if a buyer or seller agent's leads and appointments are sufficient under a predetermined ratio or percentage but the agents sales are not high enough the system triggers a training module request to the agent. If an agent does not complete the training suggested, an alert may be sent to a manager.

For example, the analytic triggers are based on any percentage the supervisor inputs: 100 leads should equal 5 appointments or 5% conversion ratio of lead to appointment. If the ratio falls below the percentage specified by the supervisor, the system would suggest the appropriate training that pertains to that action as described above.

In a third embodiment of the present invention, users of the system are selectively shown properties in a predetermined price range based on the web browser being used. The system automatically recognizes the browser the user is using to search on the system using methods known in the prior art to those skilled in the art. The system displays properties in a predetermined price range that correlates to the browser in use.

For example, if $200,000 is the average price range of the home in the location being search (zip code, city, etc.) the system will display homes based on the following percentages: Safari browsers-plus 30% or $260,000; Google Chrome or Firefox-plus 20% or $240,000; Internet Explorer-average or $200,000; Old versions of Internet Explorer-50% of baseline or $100,000.

For the purposes of promoting an understanding of the principles of the invention, reference has been made to the preferred embodiments illustrated in the drawings, and specific language has been used to describe these embodiments. However, this specific language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for managing real estate using a computer-implemented real estate management program, the method comprising:
generating a user login to allow user to view real estate properties;
generating a user profile stored in a database containing at least the user's phone number and email address;
correlating user views of real estate properties with the user profile in the database;
tracking the number of correlated views by the same user;
accessing the profile stored in the database to generate a notification to the user based upon the correlated views when the correlated views reach a predetermined number of instances for at least one real estate property.

2. The method of claim 1 wherein the notification is sent as a voice message to the user's phone number.

3. The method of claim 1 wherein the notification is sent as a text message to the user's phone number.

4. The method of claim 1 wherein the notification is sent as a text message to the user's email address.

5. The method of claim 2 wherein the notification is sent to the user's phone number during a predetermined time frame after a predetermined number of correlated views.

6. The method of claim 3 wherein the notification is sent to the user's phone number during a predetermined time frame after a predetermined number of correlated views.

7. The method of claim 4 wherein the notification is sent to the user's email address during a predetermined time frame after a predetermined number of correlated views.

8. The method of claim 1 further comprising:
using a web browser to view the real estate properties in a selected location;
determining the web browser used;
setting a web browser price range based on the web browser used using a predetermined set of parameters;
calculating the average price of real estate properties in a predetermined area around the selected location;
correlating a display price range around the calculated average price of real estate properties to the web browser price range; and
displaying real estate properties within the display price range.

9. The method of claim 8 wherein the location is a zip code or city and state selected by user.

10. The method of claim 8 wherein the location is the user's IP address.

11. A method for managing real estate using a computer-implemented real estate management program, the method comprising
generating a user login associated with a user profile stored in a database;
tracking the user's number of leads, number of appointments set and number of closed sales of real estate properties;
associating the user's number of leads, number of appointments set and number of closed sales of real estate properties with the user profile in the database;
generating at least one training module;
accessing the database to view a user profile with respect to the number of leads, number of appointments set and number of closed sales within a predetermined time frame; and
determining a ratio between user's number of leads and number of appointments set and comparing to a predetermined ratio value wherein if the ratio of user's number of leads to number of appointments set is higher than the predetermined ratio, the user is prompted to complete the at least one training module.

12. The method of claim 11 further comprising determining a ratio between user's number of appointments and number of closed sales and comparing to a predetermined ratio value wherein if the ratio of user's number of appointments to number of closed sales is higher than the predetermined ratio, the user is prompted to complete the at least one training module.

13. The method of claim 11 further comprising accessing the database to view a user's total amount of sales within a predetermined time frame and determining an amount of sales wherein if the user's total amount of sales within the predetermined time frame is below a predetermined value, the user is prompted to complete the at least one training module.

14. The method of claim 11 further comprising alerting the user's manager in the event the user fails to complete the training module.

15. The method of claim 12 further comprising alerting the user's manager in the event the user fails to complete the training module.

16. The method of claim 13 further comprising alerting the user's manager in the event the user fails to complete the training module.

17. A method for selectively presenting real estate properties in a web browser using a computer-implemented system, the method comprising:
selecting a location of real estate properties;
determining the web browser used to select location;
setting a web browser price range based on the web browser used using a predetermined set of parameters;
calculating the average price of real estate properties in a predetermined area around the selected location;
correlating a display price range around the calculated average price of real estate properties to the web browser; and
displaying real estate properties within the display price range.

18. The method of claim 17 wherein the location is a zip code selected by the user.

19. The method of claim 17 wherein the location is a city and state selected by the user.

20. The method of claim 17 wherein the location is the user's IP address.
